(19) United States
(12) Patent Application Publication
(10) Pub. No.: US 2016/0263930 A1
(43) Pub. Date: Sep. 15, 2016

(54) NEGATIVE WORKING, HEAT-SENSITIVE LITHOGRAPHIC PRINTING PLATE PRECURSOR

(71) Applicant: AGFA GRAPHICS NV, Mortsel (BE)

(72) Inventors: Jens LENAERTS, Mortsel (BE); Dirk FAES, Mortsel (BE); Isabelle ORDONEZ, Mortsel (BE)

(21) Appl. No.: 15/032,339

(22) PCT Filed: Nov. 4, 2014
(86) PCT No.: PCT/EP2014/073634

§ 371 Date: Apr. 27, 2016

(30) Foreign Application Priority Data
Nov. 7, 2013 (EP) 13191895.5

(51) Int. Cl. B41N 1/14; B41C 1/10

(52) U.S. Cl. CPC B41N 1/14; B41C 1/1058

(57) ABSTRACT

A heat-sensitive negative-working lithographic printing plate precursor includes a grained and anodized aluminium support, and a coating provided thereon, the coating containing an image-recording layer which includes hydrophobic thermoplastic polymer particles, a binder, and an infrared absorbing dye characterized in that the grained and anodized surface of the support has a CIE 1976 L*-value between 55 and 75.

### CROSS-REFERENCE TO RELATED APPLICATIONS

This application is a 371 National Stage Application of PCT/EP2014/073634, filed Nov. 4, 2014. This application claims the benefit of European Application No. 13191895.5, filed Nov. 7, 2013, which is incorporated by reference herein in its entirety.

### BACKGROUND OF THE INVENTION

1. Field of the Invention

The present invention relates to a heat-sensitive, negative-working lithographic printing plate precursor.

2. Description of the Related Art

Lithographic printing presses use a so-called printing master such as a printing plate which is mounted on a cylinder of the printing press. The master carries a lithographic image on its surface and a print is obtained by applying ink to said image and then transferring the ink from the master onto a receiver material, which is typically paper. In conventional, so-called “wet” lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-adhesive (ink-repelling) areas and during driographic printing, only ink is supplied to the master.

Printing masters are generally obtained by the image-wise exposure and processing of an imaging material called plate precursor. In addition to the well-known photosensitive, so-called pre-sensitized plates, which are suitable for UV contact exposure through a film mask, also heat-sensitive printing plate precursors have become very popular in the late 1990s. Such thermal materials offer the advantage of daylight stability and are especially used in the so-called computer-to-plate method wherein the plate precursor is directly exposed, i.e. without the use of a film mask. The material is exposed to heat or to infrared light and the generated heat triggers a (physico-)chemical process, such as ablation, polymerization, insolubilization by cross linking of a polymer, heat-induced solubilization, or particle coagulation of a thermoplastic polymer latex.

The most popular thermal plates form an image by a heat-induced solubility difference in an alkaline developer between exposed and non-exposed areas of the coating. The coating typically comprises an oleophilic binder, e.g. a phenolic resin, of which the rate of dissolution in the developer is either reduced (negative working) or increased (positive working), by the image-wise exposure. During processing, the solubility differential leads to the removal of the non-image (non-printing) areas of the coating, thereby revealing the hydrophilic support, while the image (printing) areas of the coating remain on the support. Typical examples of such plates are described in e.g. EP 625 728, EP 823 327, EP 825 927, EP 864 420, EP 894 622 and EP 901 902. Negative working preferred embodiments of such thermal materials often require a pre-heat step between exposure and development as described in e.g. EP 625 728.

Negative working plate precursors which do not require a pre-heat step may contain an image-recording layer that works by heat-induced particle coalescence of a thermoplastic polymer latex, as described in e.g. EP 770 494, EP 770 495, EP 770 496 and EP 770 497. These patents disclose a method for making a lithographic printing plate comprising the steps of (1) image-wise exposing an imaging element comprising hydrophobic thermoplastic polymer particles dispersed in a hydrophilic binder and a compound capable of converting light into heat and (2) developing the image-wise exposed element by applying fountain and/or ink.

EP 1 342 568 describes a method of making a lithographic printing plate comprising the steps of (1) image-wise exposing an imaging element comprising hydrophobic thermoplastic polymer particles dispersed in a hydrophilic binder and a compound capable of converting light into heat and (2) developing the image-wise exposed element by applying a gum solution, thereby removing non-exposed areas of the coating from the support.

EP 1 817 166 describes a method for preparing a lithographic printing plate which comprises the steps of (1) image-wise exposing an imaging element comprising hydrophobic thermoplastic polymer particles dispersed in a hydrophilic binder and a compound capable of converting light into heat and (2) developing the image-wise exposed element by applying a gum solution, thereby removing non-exposed areas of the coating from the support and characterised by an average particle size of the thermoplastic polymer particles between 40 nm and 63 nm and wherein the amount of the hydrophobic thermoplastic polymer particles is more than 70% and less than 85% by weight, relative to the image recording layer. The amount of infrared absorbing dye used in this invention is preferably more than 6% by weight relative to the image recording layer.

EP 1 614 538 describes a negative working lithographic printing plate precursor which comprises a support having a hydrophilic surface or which is provided with a hydrophilic layer and a coating provided thereon, the coating comprising an image-recording layer which comprises hydrophobic thermoplastic polymer particles and a hydrophilic binder, characterised in that the hydrophobic thermoplastic polymer particles have an average particle size in the range from 45 nm to 63 nm, and that the amount of the hydrophobic thermoplastic polymer particles in the image-recording layer is at least 70% by weight relative to the image-recording layer. The amount of IR dye used in this invention is preferably more then 6%, more preferably more then 8%, by weight relative to the image recording layer.

EP 1 614 539 and EP 1 614 540 describes a method of making a lithographic printing plate comprising the steps of (1) image-wise exposing an imaging element disclosed in EP 1 614 538 and (2) developing the image-wise exposed element by applying an aqueous, alkaline solution.

WO 2010/031758 discloses a lithographic printing plate precursor with an improved sensitivity including a coating containing thermoplastic polymer particles and an infrared radiation absorbing containing a substituent selected from bromo and iodo.

EP 1 564 020 describes a printing plate comprising a hydrophilic support and provided thereon, an image formation layer containing thermoplastic resin particles in an amount form 60 to 100% by weight, the thermoplastic particles having a glass transition point (Tg) and an average particle size of from 0.01 to 2 μm, more preferably from 0.1 to 2 μm. As thermoplastic particles, polyester resins are preferred. EP 1 564 020 discloses printing plate precursors comprising polyester thermoplastic particles, of which the particle size is 160 nm.

EP 1 834 764 describes a negative working lithographic printing plate precursor which comprises a support having a hydrophilic surface or which is provided with a hydrophilic layer and a coating provided thereon, said coating comprising an image-recording layer which comprises hydrophobic thermoplastic polymer particles and a hydrophilic binder, characterised in that said hydrophobic thermoplastic polymer particles comprise a polyester and have an average particle diameter from 18 nm to 50 nm.

A problem associated with plate precursors that work according to the mechanism of heat-induced latex coalescence is that it is difficult to obtain both a high sensitivity enabling exposure at a low energy density, and a good clean-out of the unexposed areas during development i.e. the complete removal of the non-exposed areas during the development step. The energy density that is required to obtain a sufficient degree of latex coalescence and of adherence of the exposed areas to the support is often higher than 250 mJ/cm². As a result, in platesetters that are equipped with low power exposure devices such as semiconductor infrared laser diodes, such materials require long exposure times. Also, when a low power exposure device is used, the extent of coalescence is often low and the exposed areas may degrade rapidly during the press run and as a result, a low run-length is obtained.

A higher sensitivity can be obtained e.g. by providing an image-recording layer that has a better resistance towards the developer in the unexposed state, so that a low energy density suffices to render the imagerecording layer completely resistant to the developer. However, such an imagerecording layer is difficult to remove during development (i.e. clean-out) and results in toning on the press i.e. an undesirable increased tendency of ink-acceptance in the non-image areas. This toning especially occurs when the plate is baked after development. Alternatively, decreasing the particle size of the thermoplastic particles used in the printing plate may improve the sensitivity, however, also here the complete removal of the non-exposed areas during the development step becomes troublesome. This clean-out problem tends to become worse when the particle size of the thermoplastic particles used in the printing plate decreases, as mentioned in EP 1 614 538, EP 1 614 539, EP 1 614 540 and EP 1 817 166.

Another way to provide a higher sensitivity can be achieved by using latex particles that are only weakly stabilized so that they coalesce readily i.e. upon exposure at a low energy density. However, such latex particles tend to remain on the support also in the unexposed state and again, an insufficient clean-out (removal of the coating during development) is obtained, resulting in toning. On the other hand, well-stabilized latex particles are easily removed from the support and show no clean-out problems but they require more energy to coalesce and thus a low sensitivity plate is obtained.

There is a continuous need to further improve the properties of lithographic printing plates based on coalescence of thermoplastic particles. Especially an increase of the sensitivity, without adversely affecting the other lithographic properties such as for example the clean-out behaviour and/or the run length, would render this type of printing plates even more competitive.

### SUMMARY OF THE INVENTION

It is an object of the present invention to provide a negative working, heat-sensitive lithographic printing plate precursor, that works according to the mechanism of heat-induced latex coalescence having a high sensitivity, a high run length and excellent printing properties with reduced or without toning.

This object is realized with a heat-sensitive negative-working lithographic printing plate precursor comprising a grained and anodized support and a coating provided thereon, said coating comprising an image recording layer which comprises hydrophobic thermoplastic polymer particles, a binder and an infrared absorbing dye characterized in that the surface of the support has a CIE 1976 L*-value ranging between 55 and 75.

It has been surprisingly found that a printing plate based on coalescence of hydrophobic thermoplastic particles including a support characterized with a low CIE 1976 L*-value—measured at the grained and anodized surface of the support—is characterized by a high sensitivity combined with good clean-out during processing, a high run length on the press and a low tendency of toning. This effect is even more pronounced when an infrared absorbing agent including an indenyl group is present in the image recording layer.

Preferred embodiments of the present invention are defined below.

### DETAILED DESCRIPTION OF THE PREFERRED EMBODIMENTS

The lithographic printing plate precursor comprises a coating on a hydrophilic support. The coating may comprise one or more layer(s). The layer of the coating comprising the hydrophobic thermoplastic particles is referred to herein as the image recording layer. In a preferred embodiment, the coating consists of the image recording layer only.

The lithographic printing plate precursor of a preferred embodiment of the present invention comprises a grained and anodized aluminum support. The support may be a sheet-like material such as a plate or it may be a cylindrical element such as a sleeve which can be slid around a print cylinder of a printing press.

The aluminum support has a thickness of about 0.1-0.6 mm. However, this thickness can be changed appropriately depending on the size of the printing plate used and/or the size of the platesetters on which the printing plate precursors are exposed. The aluminium is preferably grained by electrochemical graining, and anodized by anodizing techniques employing phosphoric acid, sulphuric acid or a sulphuric acid/phosphoric acid mixture. Methods of both graining and anodization of aluminum are well known in the art.

By graining (or roughening) the aluminum support, both the adhesion of the printing image and the wetting characteristics of the non-image areas are improved. By varying the type and/or concentration of the electrolyte and the applied voltage in the graining step, different types of grains can be obtained. During the electrochemical graining step a so-called smut layer (Al(OH)₃ layer) is built up.

The graining step may be carried out in an aqueous electrolyte solution containing preferably at least one of the following chemicals: HNO₃, CH₃COOH, HCl and/or H₃PO₄. In a preferred embodiment, the graining step is carried out in an electrolyte solution containing a mixture of HCl and CH₃COOH. The electrolyte solution may contain other chemicals such as surfactants, salts e.g. Al³⁺ or SO₄²⁻ salts, and additives such as benzoic acid derivatives or sulphonic acid derivatives as disclosed in EP 1 826 022. The concentration of HCl, HNO₃, CH₃COOH and/or H₃PO₄ in the electrolyte solution preferably varies between 1 g/l and 50 g/l; more preferably between 5 g/l and 30 g/l; most preferably between 6 g/l and 20 g/l. The electrolyte temperature may be at any suitable temperature but preferably ranges from 25° C. to 55° C., more preferably from 25° C. to 45° C. The graining may be carried out using a charge density preferably ranging between 80 and 2000 C/dm², more preferably between 100 and 1500 C/dm² and most preferably between 150 and 1250 C/dm² and a current density preferably ranging between 10 A/dm² to 200 A/dm², more preferably from 20 A/dm² to 150 A/dm² and most preferably from 25 A/dm² to 100 A/dm².

Preferably, the support according to a preferred embodiment of the present invention is obtained by graining in an electrolyte solution containing 9 to 14 g/l HCl and 7 to 20 g/l CH₃COOH. Alternatively, the support may be obtained by applying an asymmetric current density distribution during the graining process i.e. a higher current density (30 to 50 A/dm²) during the first part (⅔ of time) of the graining process and a reduced current density (20 to 25 A/dm²) during the last part (⅓ of time) of the graining. Also, both preparation methods may be combined. Without being bound to any theoretical explanation, the inventors of the present invention assume that the level of aluminum metal particles which are typically present in the smut layer of the support influences the brightness of the support as well as the adhesion of the latex particles on the support. When the level of aluminum metal particles in the smut layer is increased, the sensitivity and the run length of the plate may be increased. The level of aluminum metal particles in the smut layer may be increased by applying an electrolyte solution containing a higher level of HCl and/or by reducing the current density at the end of the graining step as described above. The obtained support is characterized by a low brightness determined by means of colorimetric evaluation and referred to herein as “the CIE 1976 L*-value”. The CIE 1976 L*-value ranges from 0=black to 100=white. It was surprisingly found that a printing plate precursor including a support having a low CIE 1976 L*-value (measured at the surface of the support), as defined hereafter, results in a printing plate with a significantly improved sensitivity without affecting the lithographic quality of the plate. The support according to a preferred embodiment of the present invention has a brightness defined by the CIE 1976 L*-value between 55 and 75. Preferably the support has a brightness between 60 and 74, more preferably between 65 and 73.5 and most preferably between 70 and 73.5. The CIE 1976 L*-value of the support is unaffected by the coating and development step and can thus be measured after removal of the coating by for example wiping with a cotton pad soaked in a gum solution having a neutral pH (pH=7) whereby the coating is substantially removed from the support without substantially affecting the smut layer of the support. The gum solution is an aqueous solution containing per liter water 38 g/l potato dextrine (from AVEBE BA), 27 ml/l potassium dihydrogenphosphate (from Merck), 10 ml/l potassium hydroxide (from Tessenderlo Chemie), 20 ml/l Dowfax 3B2 (from Dow Chemical) and 0.75 ml/l Marlon A365 (from Sasol). The CIE 1976 L*-value is obtained from reflection measurement in a 45/0 geometry (non-polarized), using CIE 2° as observer and D50 as illuminant. More details of the measurement can be found in CIE S 014-4/E: 2007 Colourimetry—Part 4: CIE 1976 L*a*b* Colour Spaces and CIE publications: CIE S 014-1/E:2006, CIE Standard Colourimetric Observers. The CIE 1976 L*-value of the support reported herein have been measured with a Gretag Macbeth SpectroEye with the settings: D50 (illuminant), 2° Observer, No filter.

The surface roughness of the support, expressed as arithmetical mean center-line roughness Ra (measured with a Perthometer following ISO 4288 and ISO 3274, needle geometry 2/60° and 15 mg load), may vary between 0.05 and 1.5 μm. The aluminum substrate of the current invention has preferably an Ra value between 0.15 μm and 0.45 μm, more preferably between 0.20 μm and 0.40 μm and most preferably between 0.25 μm and 0.38 μm. The lower limit of the Ra value is preferably about 0.10 μm. More details concerning the preferred Ra values of the surface of the grained and anodized aluminum support are described in EP 1 356 926.

The grained aluminum substrate can be etched chemically with an acid or an alkali. After graining and/or etching, the smut remaining on the surface is partially removed; this is also referred to in the art as a desmut step. The partial desmut step is preferably carried out in an aqueous acidic desmut solution comprising for example H₃PO₄ and/or H₂SO₄ at a concentration varying between 10 and 600 g/l, preferably between 20 and 400 g/l, most preferably between 40 and 300 g/l. Besides the chemical composition and the concentration of the desmut solution, also its temperature and reaction time may influence the desmut step. The reaction time preferably varies between 0.5 and 30 s, more preferably between 1 and 25 s and most preferably between 1.5 and 20 s and the temperature varies preferably between 20 and 95° C., more preferably between 25 and 85° C. The desmutting step is usually carried out by dipping or spraying the support with the desmut solution.

By anodising the aluminum support, its abrasion resistance and hydrophilic nature are improved. The microstructure as well as the thickness of the Al₂O₃ layer are determined by the anodising step, the anodic weight (g/m² Al₂O₃ formed on the aluminium surface) varies between 1 and 8 g/m². The anodic weight of the current invention is preferably between 2.5 g/m² and 5.5 g/m², more preferably 3.0 g/m² and 5.0 g/m² and most preferably 3.5 g/m² and 4.5 g/m². The Al₂O₃ layer is formed beneath the remaining smut layer.

The grained and anodized aluminum support may be subject to a so-called post-anodic treatment to improve the hydrophilic character of its surface. For example, the aluminum support may be silicated by treating its surface with a solution including one or more alkali metal silicate compound(s)—such as for example a solution including an alkali metal phosphosilicate, orthosilicate, metasilicate, hydrosilicate, polysilicate or pyrosilicate—at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with a citric acid or citrate solution, gluconic acid, or tartaric acid. This treatment may be carried out at room temperature or may be carried out at a slightly elevated temperature of about 30 to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulphonic acid, polyvinylbenzenesulphonic acid, sulphuric acid esters of polyvinyl alcohol, acetals of polyvinyl alcohols formed by reaction with a sulphonated aliphatic aldehyde, polyacrylic acid or derivates such as GLASCOL E15™ commercially available from Ciba Specialty Chemicals. One or more of these post treatments may be carried out alone or in combination. More detailed descriptions of these treatments are given in GB-A 1 084 070, DE-A 4 423 140, DE-A 4 417 907, EP-A 659 909, EP-A 537 633, DE-A 4 001 466, EP-A 292 801, EP-A 291 760 and U.S. Pat. No. 4,458,005. Post-anodic treatment of a grained and anodized support with a polyvinylmethylphosphonic acid solution having a pH of 2 or lower provides printing plates with a highly improved clean out behaviour.

In a specific preferred embodiment, the support is first treated with an aqueous solution including one or more silicate compound(s) as described above followed by the treatment of the support with an aqueous solution including a compound having a carboxylic acid group and/or a phosphonic acid group, or their salts. Preferred silicate compounds are sodium or potassium orthosilicate and sodium or potassium metasilicate. Suitable examples of a compound with a carboxylic acid group and/or a phosphonic acid group and/or an ester or a salt thereof are polymers such as polyvinylphosphonic acid, polyvinylmethylphosphonic acid, phosphoric acid esters of polyvinyl alcohol, polyacrylic acid, polymethacrylic acid and a copolymer of acrylic acid and vinylphosphonic acid. A solution comprising polyvinylphosphonic acid or poly(meth)acrylic acid is highly preferred.

The hydrophobic particles have an average particle diameter of more than 10 nm and less than 40 nm, preferably of more than 15 nm and less than 38 nm, more preferably of more than 20 and less than 36 nm. The average particle diameter referred to in the current application is defined as the average particle diameter measured by Photon Correlation Spectrometry (Ø_{PCS}), also known as Quasi-Elastic or Dynamic Light-Scattering. The measurements were performed according the ISO 13321 procedure (first edition, 1996-07-01) with a Brookhaven BI-90 analyzer, commercially available from Brookhaven Instrument Company, Holtsville, N.Y., USA.

The amount of hydrophobic thermoplastic polymer particles is at least 55% wt, preferably at least 60% wt, more preferably at least 65% wt relative to the weight of all the ingredients in the image-recording layer.

The hydrophobic thermoplastic polymer particles which are present in the coating are preferably selected from polyethylene, poly-(vinyl)chloride, polymethyl(meth)acrylate, polyethyl (meth)acrylate, polyvinylidene chloride, poly(meth)acrylonitrile, polyvinyl-carbazole, polystyrene or copolymers thereof.

According to a preferred embodiment, the thermoplastic polymer particles comprise polystyrene or derivatives thereof, mixtures comprising polystyrene and poly(meth)acrylonitrile or derivatives thereof, or copolymers comprising polystyrene and poly(meth)-acrylonitrile or derivatives thereof. The latter copolymers may comprise at least 50 wt. % of polystyrene, more preferably at least 65 wt. % of polystyrene. In order to obtain sufficient resistivity towards organic chemicals such as hydrocarbons used in e.g. plate cleaners, the thermoplastic polymer particles preferably comprise at least 5 wt. %, more preferably at least 30 wt. %, of nitrogen containing units, such as (meth)acrylonitrile, as described in EP-A 1 219 416. According to the most preferred embodiment, the thermoplastic polymer particles consist essentially of styrene and acrylonitrile units in a weight ratio between 1:1 and 5:1 (styrene:acrylonitrile), e.g. in a 2:1 ratio.

In a preferred embodiment the hydrophobic thermoplastic particles do not consist of polyester.

The weight average molecular weight of the thermoplastic polymer particles may range from 5,000 to 1,000,000 g/mol.

Preferred preparation methods of the thermoplastic polymer particles are disclosed in for example EP-A 1 859 935 in paragraphs [0028] and [0029].

The coating contains one or more dyes which absorbs infrared (IR) light and converts the absorbed energy into heat. The infrared absorbing dye or IR-dye is preferably present in the image-recording layer.

The IR-dye preferably has a structure according to Formula I:

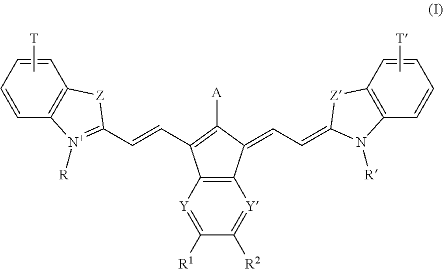

wherein

A represents hydrogen, an optionally substituted alkyl, aralkyl, aryl or heteroaryl group, halogen, —OR^{c}, —SR^{d}, —SO₂R^{e}, —NR^{f}R^{g}, —NR^{h}(SO₂Rⁱ) or —NR^{j}(CO₂R^{k}) wherein R^{c} and R^{g} independently represent an optionally substituted aryl group, R^{d}, R^{e} and R^{f} independently represent an optionally substituted alkyl, aralkyl, aryl or heteroaryl group, R^{h}, R^{j} and R^{k} independently represent an optionally substituted alkyl or aryl group, Rⁱ represents an optionally substituted alkyl or aryl group or —NRⁱ¹Rⁱ² wherein Rⁱ¹ and Rⁱ² represent hydrogen, an optionally substituted alkyl or aryl group;

Y and Y′ independently represent —CH— or —N—;

R¹ and R² independently represent hydrogen, an optionally substituted alkyl or aryl group or represent the necessary atoms to form a ring;

Z and Z′ independently represent —S—, —CH═CH— or —CR^{e}R^{f}— wherein R^{e} and R^{f} independently represent an optionally substituted alkyl aralkyl or aryl group;

R and R′ independently represent an optionally substituted alkyl group;

and T an T′ independently represent hydrogen, an alkyl group or an optionally substituted annulated benzo ring.

Preferably, R and R′ are anionic substituted alkyl groups. Preferred anionic substituted alkyl groups are selected from:

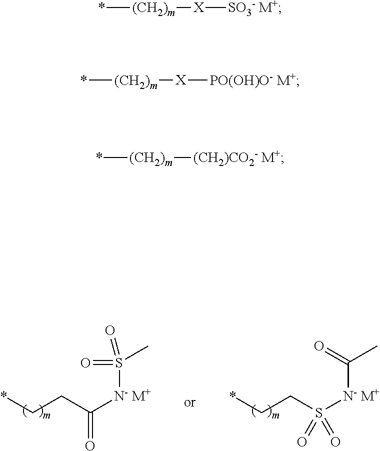

wherein

m is 1, 2, 3 or 4;

X represents O, S or —CH₂—;

M⁺ represents a counterion to balance the charge

* represents the linking position to the rest of the molecule

Suitable monovalent cations are for example —[NR^{l}R^{m}Rⁿ]⁺ wherein R^{l}, R^{m} and Rⁿ independently represent hydrogen or an alkyl group such as for example a methyl, ethyl, propyl or isopropyl group.

Preferably A represents —NR^{h}(SO₂Rⁱ) wherein R^{h} and Rⁱ are as defined above. Preferably, Rⁱ represents an optionally substituted alkyl group.

The infrared absorbing dye preferably includes an indenyl group. More preferably, the IR-dye represents structure I wherein Y and Y′ are —CH—.

In a preferred embodiment, the IR-dye has a structure according to Formula II:

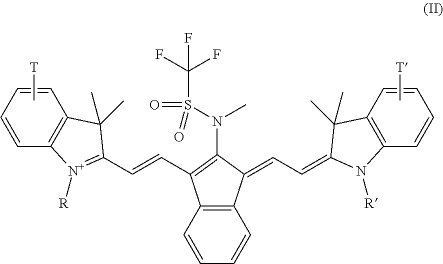

wherein R and R′, T and T′ have the same meaning as given above.

In a more preferred embodiment, the IR-dye has a structure according to Formula III:

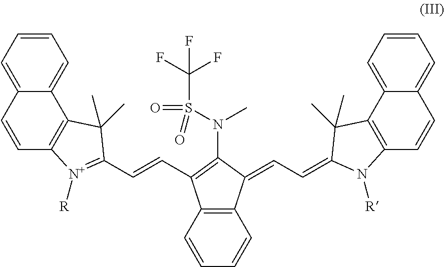

wherein R and R′ have the same meaning as described above.

The substituents optionally present on the alkyl, aralkyl, aryl or the heteroaryl group may be represented by a halogen such as a fluoro, chloro, bromo or iodo atom, a hydroxyl group, an amino group, a (di)alkylamino group or an alkoxy group.

In a preferred embodiment of the present invention, suitable alkyl groups include 1 or more carbon atoms such as for example C₁ to C₂₂-alkyl groups, more preferably C₁ to C₁₂-alkyl groups and most preferably C₁ to C₆-alkyl groups. The alkyl group may be linear or branched such as for example methyl, ethyl, propyl (n-propyl, isopropyl), butyl (n-butyl, isobutyl, t-butyl), pentyl, 1,1-dimethyl-propyl, 2,2-dimethylpropyl and 2-methyl-butyl, or hexyl. Suitable aryl groups include for example phenyl, naphthyl, benzyl, tolyl, ortho- meta- or para-xylyl, anthracenyl or phenanthrenyl. Suitable aralkyl groups include for example phenyl groups or naphthyl groups including one, two, three or more C₁ to C₆-alkyl groups. Suitable heteroaryl groups are preferably monocyclic- or polycyclic aromatic rings comprising carbon atoms and one or more heteroatoms in the ring structure. Preferably 1 to 4 heteroatoms independently selected from nitrogen, oxygen, selenium and sulphur and/or combinations thereof. Examples include pyridyl, pyrimidyl, pyrazoyl, triazinyl, imidazolyl, (1,2,3,)- and (1,2,4)-triazolyl, tetrazolyl, furyl, thienyl, isoxazolyl, thiazolyl and carbazoyl.

The most preferred IR-dye has the following structure (Formula IV):

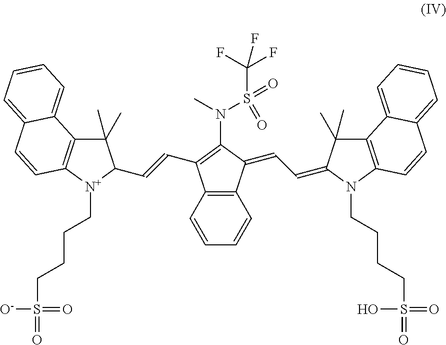 [SMILES: CN(C1=C(/C=C/C2[NH+](CCCCS(=O)(=O)[O-])c3ccc4ccccc4c3C2(C)C)c2ccccc2/C1=C\C=C1\N(CCCCS(=O)(=O)O)c2ccc3ccccc3c2C1(C)C)S(=O)(=O)C(F)(F)F]

Besides the preferred IR-dyes described above, the coating may contain one or more other IR-dye(s) such as for example cyanine, merocyanine, indoaniline, oxonol, pyrilium and squarilium dyes. Examples of such IR absorbers are described in e.g. EP-As 823 327, 978 376, 1 029 667, 1 053 868 and 1 093 934 and WOs 97/39894 and 00/29214. Other preferred IR-dyes are described in EP-A 1 614 541 (page 20 line 25 to page 44 line 29), EP-A 1 736 312 (paragraphs [0008] to [0021]), EP-A 1 910 082 and EP-A 2 072 570. These IR-dyes are especially preferred in the on-press development preferred embodiment of this invention since these dyes give rise to a print-out image after exposure to IR-light, prior to development on press. IR-dyes preferably used in this invention are water compatible, most preferably water soluble.

The infrared dye(s) are preferably present in the coating by at least 6% by weight, more preferably at least 8% by weight, relative to the total weight of the ingredients of the image recording layer. As described in EP-A 1 859 936, the amount of infrared dye may be adjusted to the particle size of the thermoplastic particles.

The coating may further contain a hydrophilic binder. Examples of suitable hydrophilic binders are homopolymers and copolymers of vinyl alcohol, (meth)acrylamide, methylol (meth)acrylamide, (meth)acrylic acid, hydroxyethyl (meth)acrylate, maleic anhydride/vinylmethylether copolymers, copolymers of (meth)acrylic acid or vinylalcohol with styrene sulphonic acid.

Preferably, the hydrophilic binder comprises polyvinylalcohol or polyacrylic acid.

The amount of hydrophilic binder may be between 2 and 30% by weight, preferably between 2 and 20% by weight, more preferably between 3 and 10% by weight relative to the total weight of all ingredients of the coating. The amount of the hydrophobic thermoplastic polymer particles relative to the amount of the binder is preferably between 4 and 15, more preferably between 5 and 12, most preferably between 6 and 10.

Colorants, such as dyes or pigments, which provide a visible color to the coating and remain in the exposed areas of the coating after the processing step, may be added to the coating. The image-areas, which are not removed during the processing step, form a visible image on the printing plate and inspection of the lithographic image on the developed printing plate becomes feasible. Typical examples of such contrast dyes are the amino-substituted tri- or diarylmethane dyes, e.g. crystal violet, methyl violet, victoria pure blue, flexoblau 630, basonylblau 640, auramine and malachite green. Also the dyes which are discussed in depth in the detailed description of EP-A 400 706 are suitable contrast dyes. In a preferred embodiment, anionic tri- or diaryl-methane dyes are used. Dyes which, combined with specific additives, only slightly color the coating but which become intensively colored after exposure, as described in for example WO2006/005688 are also of interest. Other preferred contrast dyes are those described in EP-A 1 914 069. Pigments of interest are phtalocyanine and quinacridones pigments such as for example Heliogen Blau commercially available from BASF and PV23 (IJX1880) commercially available from Cabot Corporation.

Typical contrast dyes may be combined or even replaced by infrared dyes capable of forming a visible colour upon exposure to infrared radiation, as those described in EP-A 1 736 312 and EP-A 1 910 082.

The coating may further comprise a light stabiliser and/or anti-oxidant. Suitable light stabilizers and/or anti-oxidants are steric hindered phenoles, hindered amine light stabilizers (HALS) and their N-oxyl radicals, tocopheroles, hydroxyl amine derivatives, such as hydroxamic acids and substituted hydroxylamines, hydrazides, thioethers or trivalent organophosphor compounds such as phosphites and reductones. Preferably, the light stabilizer is a reductone. In a particular preferred embodiment, the coating comprises a phenolic compound containing a phenolic ring having at least one substituent according to Formula V (see below) and optional additional substituents having a Hammett sigma para-value (σₚ) less than or equal to 0.3. The phenolic compound preferably contains phenol, naphthol or a hydroxy substituted indole. Preferred substituents having a Hammett sigma para-value (σₚ) less than or equal to 0.3 are for example an optionally substituted alkyl or aryl group, a halogen, an alkoxy group, a thioether, an amino group and a hydroxyl group.

The substituent according to Formula V has the following structure:

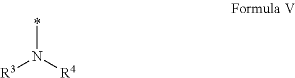

wherein
* is a linking position to the aromatic ring of the phenolic compound; and

R³ and R⁴ are independently represented by hydrogen, an optionally substituted alkyl group, an optionally substituted alkenyl group, an optionally substituted alkynyl group, an optionally substituted alkaryl group, an optionally substituted aralkyl group and an optionally substituted aryl or heteroaryl group;

R³ and R⁴ may represent the necessary atoms to form a five to eight membered ring, with the proviso that R³ and R⁴ are bonded to N via a carbon-nitrogen bond;

any of R³ and R⁴ together with N and the phenolic ring may represent the necessary atoms to form a five or six membered ring.

Optionally, the coating may further contain additional ingredients. For example, additional binders, polymer particles such as matting agents and spacers, surfactants such as perfluoro-surfactants, silicon or titanium dioxide particles, development inhibitors, development accelerators, colorants, metal complexing agents are well-known components of lithographic coatings.

Preferably the coating comprises an organic compound, including at least one phosphonic acid group or at least one phosphoric acid group or a salt thereof, as described in EP 1 940 620. These compounds may be present in the coating in an amount between 0.05 and 15% by weight, preferably between 0.5 and 10% by weight, more preferably between 1 and 5% by weight relative to the total weight of the ingredients of the coating.

The ingredients present in the coating as described above may be present in the image-recording layer or in an optional other layer.

To protect the surface of the coating, in particular from mechanical damage, a protective layer may optionally be applied on the image-recording layer. The protective layer generally comprises at least one water-soluble polymeric binder, such as polyvinyl alcohol, polyvinylpyrrolidone, partially hydrolyzed polyvinyl acetates, gelatin, carbohydrates or hydroxyethylcellulose. The protective layer may contain small amounts, i.e. less then 5% by weight, of organic solvents. The thickness of the protective layer is not particularly limited but preferably is up to 5.0 μm, more preferably from 0.05 to 3.0 μm, particularly preferably from 0.10 to 1.0 μm.

The coating may be applied on the support by any coating technique known in the art. After applying the coating, the applied layer(s) are dried as commonly known in the art.

The printing plate precursor is preferably exposed with infrared light, preferably near infrared light. The infrared light is converted into heat by an IR-dye as discussed above. The heat-sensitive lithographic printing plate precursor of a preferred embodiment the present invention is preferably not sensitive to visible light. Most preferably, the coating is not sensitive to ambient daylight, i.e. visible (400-750 nm) and near UV light (300-400 nm) at an intensity and exposure time corresponding to normal working conditions so that the material can be handled without the need for a safe light environment.

The printing plate precursors of the present invention can be exposed to infrared light by e.g. LEDs or an infrared laser. Preferably lasers, emitting near infrared light having a wavelength in the range from about 700 to about 1500 nm, e.g. a semiconductor laser diode, a Nd:YAG or a Nd:YLF laser, are used. Most preferably, a laser emitting in the range between 780 and 830 nm is used. The required laser power depends on the sensitivity of the image-recording layer, the pixel dwell time of the laser beam, which is determined by the spot diameter (typical value of modern plate-setters at 1/e² of maximum intensity: 10-25 μm), the scan speed and the resolution of the exposure apparatus (i.e. the number of addressable pixels per unit of linear distance, often expressed in dots per inch or dpi; typical value: 1000-4000 dpi).

Preferred lithographic printing plate precursors according to the present invention produce a useful lithographic image upon image-wise exposure with IR-light having an energy density, measured at the surface of said precursor, of 200 mJ/cm² or less, more preferably of 180 mJ/cm² or less, even more preferably of 165 mJ/cm² or less, and most preferably of 150 mJ/cm² or less. With a useful lithographic image on the printing plate, 2% dots (at 200 lpi) are perfectly visible on at least 1000 prints on paper. Exposure is preferably carried out with commercially available platesetters.

Two types of laser-exposure apparatuses are commonly used: internal (ITD) and external drum (XTD) platesetters. ITD platesetters for thermal plates are typically characterized by a very high scan speed up to 1500 m/sec and may require a laser power of several Watts. The Agfa Galileo T (trademark of Agfa Gevaert N.V.) is a typical example of a plate-setter using the ITD-technology. XTD platesetters for thermal plates having a typical laser power from about 20 mW to about 500 mW operate at a lower scan speed, e.g. from 0.1 to 20 m/sec. The Agfa Xcalibur, Accento and Avalon platesetter families (trademark of Agfa Gevaert N.V.) make use of the XTD technology.

As an alternative, the printing plate precursor may be imagewise heated by a heating element to form an image.

Due to the heat generated during the exposure step, the hydrophobic thermoplastic polymer particles may fuse or coagulate so as to form a hydrophobic phase which corresponds to the printing areas of the printing plate. Coagulation may result from heat-induced coalescence, softening or melting of the thermoplastic polymer particles. There is no specific upper limit to the coagulation temperature of the thermoplastic hydrophobic polymer particles, however the temperature should be sufficiently below the decomposition temperature of the polymer particles. Preferably the coagulation temperature is at least 10° C. below the temperature at which the decomposition of the polymer particles occurs. The coagulation temperature is preferably higher than 50° C., more preferably above 100° C.

In the development step after the exposure step, the non-exposed areas of the image-recording layer are at least partially removed without essentially removing the exposed areas, i.e. without affecting the exposed areas to an extent that renders the ink-acceptance of the exposed areas unacceptable.

The printing plate precursor may be developed off-press by means of a suitable processing liquid. The processing liquid can be applied to the plate e.g. by rubbing with an impregnated pad, by dipping, immersing, (spin-)coating, spraying, pouring-on, either by hand or in an automatic processing apparatus. The treatment with a processing liquid may be combined with mechanical rubbing, e.g. by a rotating brush. The developed plate precursor can, if required, be post-treated with rinse water, a suitable correcting agent or preservative as known in the art. During the development step, any water-soluble protective layer present is preferably also removed. Suitable processing liquids are plain water, an alkaline solution or an aqueous solution. In a preferred embodiment, the processing liquid is a gum solution. A suitable gum solution which can be used in the development step is described in for example EP 1 342 568 and WO 2005/111727. The development is preferably carried out at temperatures of from 20 to 40° C. in automated processing units as customary in the art. The development step may be followed by a rinsing step and/or a gumming step.

In another preferred embodiment, the printing plate precursor is after exposure mounted on a printing press and developed on-press by supplying ink and/or fountain or a single fluid ink to the precursor. Alternatively, development off press with e.g. a gumming solution, wherein the non-exposed areas of the image recording layer are partially removed, may be combined with a development on-press, wherein a complete removal of the non-exposed is realised.

The plate precursor may be post-treated with a suitable correcting agent or preservative as known in the art. To increase the resistance of the finished printing plate and hence to extend the run length, the layer can be heated to elevated temperatures (so called “baking”). The plate can be dried before baking or is dried during the baking process itself. During the baking step, the plate can be heated at a temperature which is higher than the glass transition temperature of the thermoplastic particles. The baking period is preferably more than 15 seconds, more preferably more than 20 seconds and most preferably the baking period is less than 2 minutes. A preferred baking temperature is above 60° C., more preferably above 100° C. For example, the exposed and developed plates can be baked at a temperature of 230° C. to 250° C. for about 30 seconds to 1.5 minutes. Baking can be done in conventional hot air ovens or by irradiation with lamps emitting in the infrared or ultraviolet spectrum. As a result of this baking step, the resistance of the printing plate to plate cleaners, correction agents and UV-curable printing inks increases. A baking process as disclosed in EP-A 1 767 349 may also be applied in the present invention.

The printing plate thus obtained can be used for conventional, so-called wet offset printing, in which ink and an aqueous dampening liquid is supplied to the plate. Another suitable printing method uses so-called single-fluid ink without a dampening liquid. Suitable single-fluid inks have been described in U.S. Pat. No. 4,045,232, U.S. Pat. No. 4,981,517 and U.S. Pat. No. 6,140,392. In a most preferred embodiment, the single-fluid ink comprises an ink phase, also called the hydrophobic or oleophilic phase, and a polyol phase as described in WO 00/32705.

### EXAMPLES

While the present invention will hereinafter be described in connection with preferred embodiments thereof, it will be understood that it is not intended to limit the invention to those preferred embodiments.

### Preparation of the Inventive Lithographic Substrate S-01

A 0.3 mm thick aluminum foil was degreased by dipping in an aqueous solution containing 10 g/l NaOH at 50° C. for 15 seconds and rinsed with demineralised water for 5 seconds followed by a rinsing with a diluted HCl solution with a conductivity of 100 mS. The foil was then electrochemically grained using an alternating current (50 Hz) in an aqueous solution containing 10.5 g/l HCl and 15 g/l HOAc at a temperature of 30° C. and a current density of 35 A/dm² and a total charge density of 500 C/dm². Afterwards, the aluminum foil was rinsed with demineralised water and partially desmutted by etching with an aqueous solution containing 70 g/l of phosphoric acid at 35° C. for 20 seconds and rinsed with demineralised water for 5 seconds. The foil was subsequently subjected to anodic oxidation during 15 seconds in an aqueous solution containing 145 g/l of sulphuric acid at a temperature of 45° C. and a current density of 20 A/dm² (charge density of 350 C/dm²), then washed with demineralised water. The post treatment is done (by dipping) with a solution containing 2.0 g/l PVPA at 70° C. After the dipping process, the supports are rinsed with demineralised water for 10 seconds and dried at 25° C. for 1 hour.

The support S-01 thus obtained is characterised by a surface roughness Ra of 0.28-0.35 μm (measured with a Perthometer following ISO 4288 and ISO 3274, needle geometry 2/60° and 15 mg load), an anodic weight of about 4.0 g/m² and an 1976 CIE 1976 L*-value of 72.5 (measured with a Gretag Macbeth SpectroEye with the settings: D50 (illuminant), 2° Observer, No filter).

### Preparation of the Comparative Lithographic Substrate S-02

The comparative support was obtained by the same procedure as given for inventive support S-01 with the difference that the electrochemical graining step was carried out in an aqueous solution containing 7.5 g/l HCl and 15 g/l HOAc.

The support S-02 thus obtained is characterised by a surface roughness Ra of 0.28-0.35 μm (measured with a Perthometer following ISO 4288 and ISO 3274, needle geometry 2/60° and 15 mg load), an anodic weight of about 4.0 g/m² and an 1976 CIE 1976 L*-value of 76.5 (measured with a Gretag Macbeth SpectroEye with the settings: D50 (illuminant), 2° Observer, No filter).

### Preparation of the Thermoplastic Particles LX-01

The polymer emulsion was prepared by means of a seeded emulsion polymerisation using styrene and acrylonitrile as monomers. All surfactant was present in the reactor before any monomer was added. In a double-jacketed reactor of 2 liter, 10.35 g of Chemfac PB-133 (Chemfac PB-133, an alkyl ether phosphate surfactant from Chemax Inc.), 1.65 g of NaHCO₃ and 1482.1 g of demineralised water was added. The reactor was flushed with nitrogen and heated until 75° C. When the reactor content reached a temperature of 75° C., 1.5% of the monomers were added (i.e. a mixture of 2.29 g styrene and 1.16 g acrylonitrile). The monomers were emulsified during 15 minutes at 75° C. followed by the addition of 37.95 gram of a 2% solution of sodium persulfate in water. The reactor was subsequently heated to a temperature of 80° C. during 30 minutes. Then, the remaining monomer mixture (150.1 g of styrene and 76.5 g of acrylonitrile) was dosed to the reaction mixture during 180 minutes. Simultaneously with the monomer addition, an additional amount of an aqueous persulfate solution was added (37.95 g. of a 2% aqueous Na₂S₂O₈ solution). After the monomer addition was completed, the reactor was heated for 60 minutes at 80° C. To reduce the amount of residual monomer a vacuum distillation was performed at 80° C. during 1 hour. The reactor was subsequently cooled to room temperature, 100 ppm Proxel Ultra 5 (an aqueous 5 wt. % solution of 1,2 benzisothiazole-3(2H)-one from Arch Biocides UK) was added as biocide and the latex was filtered using coarse filter paper.

This resulted in a latex dispersion LX-01 with a solid content of 13.14 wt. % and a pH of 6.10. The average particle size was 31 nm as measured with a Brookhaven BI-90 analyzer, commercially available from Brookhaven Instrument Company, Holtsville, N.Y., USA. The measurements were performed according the ISO 13321 procedure (first edition, 1996-07-01).

### Example 1

### Printing Plates PP-01 to PP-04

### Preparation of the Coating Solutions CS-1 and CS-2.

Table 1 lists the dry coating weight of the ingredients used in the preparation of the coating solutions. The latex dispersion LX-01 was added to demineralized water and the obtained dispersion was stirred for 5 minutes. Subsequently the IR-dye (IR-01 or IR-02) was added and the solution was stirred for 30 minutes. Pigment-01, pigment-02, the polyacrylic acid binder and stabiliser L-5 were added each with 2 minutes of stirring in between. Subsequently, HEDP was added, followed by 5 minutes of stirring and finally the surfactant Zonyl FS0100 was added.

The obtained coating dispersion was stirred for 30 minutes and the pH was adjusted to a value of 3.2.

TABLE 1
Dry coating weight of the ingredients used in the
coating solutions CS-01 and CS-02

| | CS-01 | CS-02 |
|---|---|---|
| Ingredients* | g/m² | g/m² |
| Latex LX-01 (1) | 400.0 | 400.0 |
| Polyacrylic Acid binder (2) | 32.0 | 32.0 |
| IR-01 (3) | 68.4 | — |
| IR-02 (4) | — | 62.9 |
| Pigment-01 (5) | 20.0 | 20.0 |
| Pigment-02 (6) | 20.0 | 20.0 |
| Stabilizer L-5 (7) | 5.0 | 5.0 |
| HEDP (8) | 25.7 | 25.7 |
| Zonyl FS0100 (9) | 5.0 | 5.0 |

*active ingredients in the coating

1) Latex LX-01, see above;

2) Aqueous solution containing 1.5 wt. % Aqualic AS58 commercially available from Nippon Shokubai

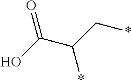 [SMILES: *CC(*)C(=O)O]

3) An aqueous dispersion containing 3.0 wt. % of IR-01:

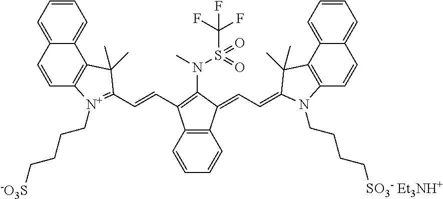

IR-01 may be prepared by well known synthesis methods such as for example disclosed in EP 2 072 570.

4) An aqueous dispersion containing 3.0 wt. % of IR-02:

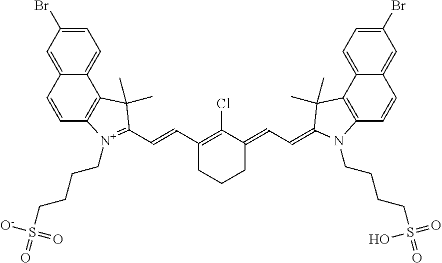 [SMILES: CC1(C)C(/C=C/C2=C(Cl)C(=C/C=C3/N(CCCCS(=O)(=O)O)c4ccc5cc(Br)ccc5c4C3(C)C)/CCC2)=[N+](CCCCS(=O)(=O)[O-])c2ccc3cc(Br)ccc3c21]

IR-02 may be prepared by well known synthesis methods such as for example disclosed in EP 2 328 753-A.

5) Pigment-01, an aqueous dispersion obtained by milling 20.0 wt. % Heliogen Blau D7490 (commercially available from BASF) with 0.4 mm pearls and stabilised with 2.0 wt. % of sodium dodecyl sulphate (commercially available from Applichem GmbH) to achieve an average particle size of 105 nm. The dispersion contains 0.1 wt. % of 1,2 benzisothiazole-3(2H)-one commercially available from Arch Biocides UK.

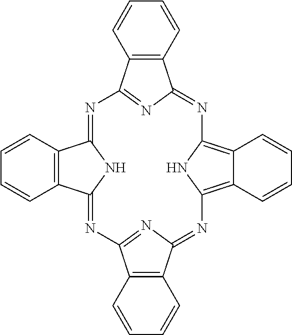 [SMILES: c1ccc2c(c1)-c1nc-2nc2[nH]c(nc3nc(nc4[nH]c(n1)c1ccccc41)-c1ccccc1-3)c1ccccc21]

6) Pigment-02, an aqueous blue pigment dispersion IJX 1880 commercially available from Cabot Corporation.

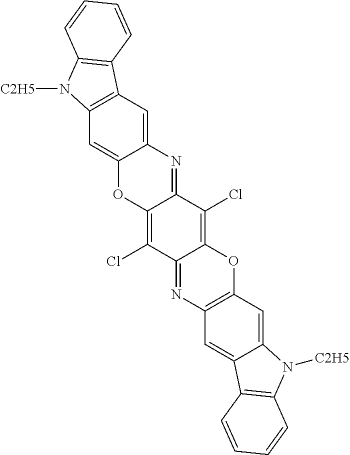 [SMILES: CCn1c2ccccc2c2cc3c(cc21)Oc1c(Cl)c2c(c(Cl)c1=N3)Oc1cc3c(cc1N=2)c1ccccc1n3CC]

7) Daylight stabiliser L-5-hydroxytryptophan, commercially available from Acros Chimica;

8) Al-ion complexing agent: an aqueous solution containing 6 wt. % 1-hydroxyethylidene-1,1-diphosphonic acid ammonium salt commercially available from Monsanto Solution Europe;

9) Zonyl FS0100, an aqueous solution containing 5 wt. % of the fluorinated surfactant Zonyl FS0100 commercially available from Dupont.

### Preparation of the Printing Plate Precursors PPP-01 to PPP-04

The coating solutions CS-01 and CS-02 were respectively coated on the inventive support S-01 and the comparative support S-02, as described above, with a coating knife at a wet thickness of 30 μm. After drying on a plate at 35° C. for 5 minutes, the printing plate precursors PPP-01 to PPP-04 were obtained with the coating composition as listed in Table 1.

### Exposure

The printing plate precursors were exposed on a Acento S 240 mW IR-laser plate-setter, trademark from Agfa Graphics N.V., at the following energy densities: 120 mJ/cm², 137 mJ/cm², 160 mJ/cm² and 180 mJ/cm² respectively.

### Development

The exposed printing plate precursors were developed and gummed in a Clean Out Unit COU 85, trademark from Agfa Graphics N.V., operating at a speed of 0.6 m/min. at 22° C. using the gum solution Azura TS gum commercially available from Agfa Graphics N.V. The printing plates PP-01 to PP-04 were obtained.

### Printing

As a reference sample, an Azura TS plate, commercially available from Agfa Graphics N.V., was exposed at an energy density of 200 mJ/cm² and subsequently developed in a Clean Out Unit COU 85, trademark from Agfa Graphics N.V., using the gum solution Azura TS gum commercially available from Agfa Graphics N.V.

The developed plates PP-01 to PP-04 and the reference sample were mounted on a Ryobi 522 HXX printing press, trademark from Ryobi. Printing was performed at a speed of 5000 sheets per hour on offset paper (80 mg/m²) using K+E 800™ black ink (Trademark of K&E) and 3% FS404As™ (trademark of Agfa Graphics N.V)/5% isopropylalcohol as fountain solution.

20000 Sheets were printed.

### Sensitivity Results

For every energy density, i.e. 120 mJ/cm², 137 mJ/cm², 160 mJ/cm² and 180 mJ/cm², the optical density of the B25 2% dot pattern was measured, using a Gretag Macbeth densitometer Type D19C device, as a function of the number of printed sheets.

A B-25 2% dot pattern consists of 2% ABS (200 lpi, 2400 dpi) dots, with a the total surface coverage of these dots of 25%. ABS dots are generated with the Agfa Balanced Screening methodology. More information about the B-25 2% dot pattern, also known as the Bayer matrix or algorithm, can be found in the article: Bayer, B.E., “An Optimum Method for Two-Level Rendition of Continuous Tone Pictures,” IEEE International Conference on Communications, Conference Records, 1973, pp. 26-11 to 26-15.

The sensitivity was determined by comparing the optical density values obtained for each plate with the optical density value obtained for the reference plate exposed at 200 mJ/cm². The sensitivity is defined as the energy density which is required to obtain a printing plate giving on printed sheet an optical density equal to the optical density given on printed sheet by the reference plate. The results of the sensitivity test are given in Table 2.

TABLE 2
Sensitivity results

| | | Average CIE 1976 L*- | |
|---|---|---|---|
| | | value of the | sensitivity |
| Printing plate | IR-dye | substrate* | (mJ/cm²) |
| PP-01, | IR-01 | 72.5 | 140 |
| inventive | | | |
| PP-02, | IR-02 | 72.5 | 160 |
| inventive | | | |
| PP-04, | IR-01 | 76.5 | 180 |
| comparative | | | |
| PP-05, | IR-02 | 76.5 | 200 |
| comparative | | | |

*The CIE 1976 L*-value of the support is measured with a Gretag Macbeth SpectroEye with the settings: D50 (illuminant), 2° Observer, No filter.

The results in Table 2 show that the sensitivity results obtained for the printing plates of the invention, i.e. the printing plates comprising the support with the low L*-value, are significantly better compared to the sensitivity results of the printing plates of the prior art, i.e. the printing plates comprising the support with the high L*-value. Especially the coating including IR-01 gives an excellent sensitivity result.

### Example 2

### Printing Plates PP-05 and PP-06

### Preparation of the Coating Solutions CS-03 and CS-04.

Table 3 lists the dry coating weight of the ingredients used in the preparation of the coating solutions CS-03 and CS-04. The coating solutions were prepared in a similar way as described in Example 1.

TABLE 3
dry coating weight of the ingredients used in the
coating solutions CS-03 and CS04

| | CS-03 | CS-04 |
|---|---|---|
| Ingredients* | g/m² | g/m² |
| Latex LX-01 (1) | 441.8 | 441.8 |
| Polyacrylic Acid binder (2) | 36.8 | 36.8 |
| IR-01 (3) | 63.0 | — |
| IR-03 (4) | 5.3 | 54.1 |
| Pigment-01 (5) | 18.4 | 18.4 |
| Pigment-02 (6) | 20.9 | 20.9 |
| Stabilizer L-5 (7) | 2.7 | 2.7 |
| HEDP (8) | 32.2 | 32.2 |
| Zonyl FS0100 (9) | 4.6 | 4.6 |

*active ingredients in the coating

(1) to (3) and (5) to (9): see Table 2;

(4) an aqueous dispersion containing 3.0 wt. % of IR-03. IR-03 may be prepared by well-known synthesis methods such as for example disclosed in EP 2 072 570. IR-03 has the following structure:

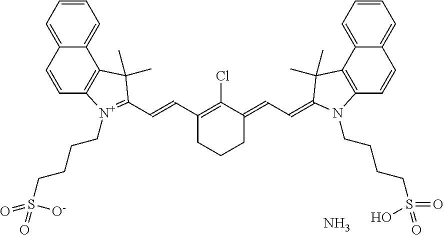

### Preparation of the Printing Plate Precursors PPP-05 and PPP-06

The coating solutions CS-03 and CS-04 were coated on the inventive lithographic support S-01 as described above, with a coating knife at a wet thickness of 30 μm. After drying on a plate at 35° C. for 5 minutes, the printing plate precursors PPP-05 and PPP-06 were obtained.

### Exposure and Development

The printing plate precursors PPP-05 to PPP-06 were exposed and developed as described in Example 1. The printing plates PP-05 and PP-06 were obtained.

### Printing and Sensitivity Results

Printing and determination of the sensitivity of the printing plates PP-05 and PP-06 was performed in the same way as in Example 1. The results of the sensitivity test are given in Table 4.

TABLE 4
Sensitivity results

| | | Average CIE | |
|---|---|---|---|
| | | 1976 L*-value | |
| Printing | | of the | sensitivity |
| plate | IR-dye | substrate* | (mJ/cm²) |
| PP-05, | IR-01 | 72.5 | 145 |
| inventive | | | |
| PP-06, | IR-03 | 72.5 | 165 |
| inventive | | | |

*The CIE 1976 L*-value of the support is measured with a Gretag Macbeth SpectroEye with the settings: D50 (illuminant), 2° Observer, No filter.

The results in Table 4 show that the inventive printing plates are characterized by an excellent sensitivity; especially the coating including IR-01.

1-10. (canceled)

11. A heat-sensitive negative-working lithographic printing plate precursor comprising:
a grained and anodized aluminum support; and
a coating provided on the grained and anodized aluminum support and including an image recording layer which includes hydrophobic thermoplastic polymer particles, a binder, and an infrared absorbing dye; wherein
a surface of the grained and anodized aluminum support has a CIE 1976 L*-value between 55 and 75.

12. The printing plate precursor according to claim 11, wherein the CIE 1976 L*-value is between 70 and 73.5.

13. The printing plate precursor according to claim 11, wherein the infrared absorbing dye has a structure accordion to Formula I: 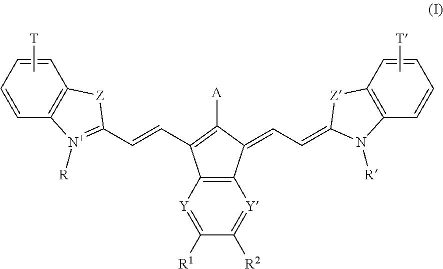
wherein
A represents hydrogen, an optionally substituted alkyl, aralkyl, aryl, or heteroaryl group, halogen, —OR^{c}, —SR^{d}, —SO₂R^{e}, —NR^{f}R^{g}, —NR^{h}(SO₂Rⁱ), or —NR^{j}(CO₂R^{k});
R^{c} and R^{g} independently represent an optionally substituted aryl group;
R^{d}, R^{e}, and R^{f} independently represent an optionally substituted alkyl, aralkyl, aryl, or heteroaryl group;
R^{h}, R^{j}, and R^{k} independently represent an optionally substituted alkyl or aryl group;
Rⁱ represents an optionally substituted alkyl or aryl group, or —NRⁱ¹Rⁱ² in which Rⁱ¹ and Rⁱ² represent hydrogen or an optionally substituted alkyl or aryl group;
Y and Y′ independently represent —CH— or —N—;
R¹ and R² independently represent hydrogen, an optionally substituted alkyl or aryl group, or necessary atoms to form a ring;
Z and Z′ independently represent —S—, —CH═CH—, or —CR^{e}′R^{f}′— in which R^{e}′ and R^{f}′ independently represent an optionally substituted alkyl group;
R and R′ independently represent an anionic substituted alkyl group; and
T and T′ independently represent an optionally substituted annulated benzo ring.

14. The printing plate precursor according to claim 13, wherein Y and Y′ in Formula I represent —CH—.

15. The printing plate precursor according to claim 13, wherein A represents —NR^{h}(SO₂Rⁱ).

16. The printing plate precursor according to claim 11, wherein the infrared dye has a structure according to Formula III: 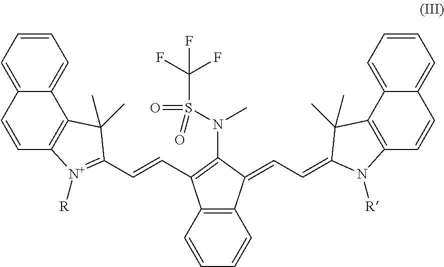
wherein R and R′ independently represent an anionic substituted alkyl group.

17. The printing plate precursor according to claim 11, wherein the grained and anodized aluminum support has a surface roughness, expressed as an arithmetical mean center-line roughness Ra, ranging between 0.25 and 0.38.

18. The printing plate precursor according to claim 11, wherein the grained and anodized aluminum support includes between 3 g/m² and 5 g/m² of aluminum oxide.

19. A method for making a lithographic printing plate comprising the steps of:
providing a printing plate precursor according to claim 11;
image-wise exposing the printing plate precursor to heat and/or infrared light; and
developing the exposed printing plate precursor.

20. The method according to claim 19, wherein the step of developing includes applying a gum solution to the exposed printing plate precursor to at least partially remove unexposed areas of the image recording layer.
